(19) United States
(12) Patent Application Publication
(10) Pub. No.: US 2011/0125802 A1
(43) Pub. Date: May 26, 2011

(54) Operating a Network Using Relational Database Methodology

(75) Inventors: Jacobus E. Van der Merwe, New Providence, NJ (US); Xu Chen, Ann Arbor, MI (US); Yun Mao, Jersey City, NJ (US); Zhuoqing M. Mao, Ann Arbor, MI (US)

(73) Assignee: AT&T INTELLECTUAL PROPERTY I, LP, Reno, NV (US)

(21) Appl. No.: 12/623,408

(22) Filed: Nov. 21, 2009

(51) Int. Cl. G06F 7/00; G06F 15/173

(52) U.S. Cl. 707/792; 707/812; 709/223; 707/E17.045; 707/E17.005

(57) ABSTRACT

In one embodiment, the disclosed technology involves modeling network elements, such as router configurations and link information, as well as any generic network status, as data in a relational database. Various network data, such as router states and link states are abstracted into tables in the relational database. Network management operations may then be represented as a series of transactional database queries and insertions. As a result, the database automatically propagates, to the appropriate network elements, state changes that are written to database tables, thereby implementing various network operations. Tables in the database can be constructed at various levels of abstraction, as required to satisfy network operational demands. Programmability is provided by a declarative language composed of a series of database queries and insertions.

### FIELD

The disclosed technology, in one embodiment, relates generally to network operation using relational database methodology.

### BACKGROUND

Network management and operational tasks are performed on a daily basis in all large operational networks. These operational tasks span a wide range of activities including (i) planned maintenance, to maintain equipment or upgrade or introduce new equipment, (ii) emergency repair, when a natural or human induced event causes failure or malfunction, (iii) fault management, to localize and replace faulty equipment, (iv) configuration management, to enable new functionality or customer features, (v) traffic/performance management, to deal with traffic growth and dynamic traffic events, (vi) security management, to deal with security incidents like worm outbreaks and DDoS attacks, (vii) network measurement and monitoring, to detect anomalies. The scale of modern networks, the diversity of the equipment used to realize their functionality, and the inherent complexity of many of these operational tasks make network management and operation one of the most significant challenges faced by network operators. This state of affairs is exacerbated by the fact that networks are always “live”—traffic associated with the myriad of services enabled by the network is continuously being carried by the network—and operational tasks have to be performed with minimal impact on existing services. To address these challenges, it is desirable to have as much automation as possible so that systems can be utilized to keep track of dependencies and constraints as network operational tasks are performed. However, the realization of a unified framework to enable fully automated network operations is a challenging task at best.

### SUMMARY

In one embodiment, the disclosed technology relates to a network operation and management system in which network elements and their status, such as router configurations and link information, as well as any generic network status, are modeled as data in a relational database. Various network data, such as router states and link states are abstracted into tables in the relational database. Network management operations may then be represented as a series of transactional database queries and insertions. As a result, the database automatically propagates, to the appropriate network elements, state changes that have been written to the database tables, thereby implementing various network operations. Tables in the database can be constructed at various levels of abstraction, as required to satisfy network operational demands. Programmability may be provided by a declarative language in which an end result is specified rather than specifying how the end result should be obtained. A rule-based language—in which rules are implemented dependent on the values of a set of data—may be used to provide flexible programmability and thereby enable the identification and enforcement of network-wide management constraints, and to achieve high-level task scheduling. Accordingly, a declarative, rule-based language may be used to interact with the database. The database may be centralized or may be distributed over various appropriate network elements.

In one embodiment, the disclosed technology involves: changing, at an address of a memory device, the address associated with a cell of a table in a relational database, data representative of a characteristic associated with a component of a network; and communicating, to a component of the network, information associated with the data change.

In another embodiment, the disclosed technology involves: receiving information associated with a change in data entered in a memory device, the data entered at a memory position of the memory device associated with a cell of at least one table of a relational database, the data being associated with a characteristic of a component of a network; and changing the characteristic of the component based on the received information.

In another embodiment, the disclosed technology involves: entering, at addresses of a memory device associated with cells of at least two tables in a relational database, data representative of characteristics associated with at least two components of a network; changing, in at least one of the tables of the database, data representative of a characteristic of at least one component of the network; and communicating, to the one component, information associated with the data change.

In another embodiment, the disclosed technology involves: entering, in a memory device, at memory positions associated with cells of at least two tables of a relational database that is distributed over a plurality of network components, data associated with characteristics of at least two components of a network; changing, in at least one of the tables of the database, data representative of a characteristic of at least one component of the network, the one component selected from the group consisting of a switch, a router and a communication link; communicating, to the one component, information associated with the data change; receiving at the one component the information associated with the data change; and changing a characteristic of the one component based on the information. In yet another embodiment, the disclosed technology involves a network including: at least two network devices; a memory device with memory positions associated with cells of at least one table of a relational database, the cells associated with at least one characteristic of at least one network device; a data entry device for entering data into the memory positions; a communication device for communicating information associated with a change in the data in a memory position associated with the at least one characteristic of the at least one network device, and the at least one network device adapted to change a characteristic of the at least one network device based on the communicated information.

In yet another embodiment, the disclosed technology involves a network including: at least two network devices; a memory device with memory positions associated with cells of at least two tables of a relational database, the cells associated with characteristics of the two network devices; a data entry device for entering data into the memory positions; a communication device for communicating to at least one network device information associated with a change in the data in a memory position associated with the one network device; the at least one network device adapted to receive the information and to change a characteristic of the device based on the information.

### BRIEF DESCRIPTION OF THE DRAWINGS

FIG. 1 is a representation of an embodiment of an apparatus used in the methodology of the disclosed technology

FIG. 1B is a representation of an embodiment of the methodology of the disclosed technology.

FIG. 2 is a schematic representation of the architecture of the disclosed technology.

FIG. 3 is a schematic representation of a computer that may be used to implement the disclosed technology.

FIG. 4. is a listing of rules for router maintenance that may be used in the disclosed technology.

FIG. 5. is a further listing of rules for router maintenance that may be used in the disclosed technology.

FIG. 6. is a further listing of rules for router maintenance that may be used in the disclosed technology.

FIG. 7. is a listing of rules for VPN monitoring and fault diagnosis that may be used in the disclosed technology.

### DETAILED DESCRIPTION

### Introduction

The disclosed technology involves a unifying operational framework for network operations in which network elements, such as router configurations and link information, as well as any generic network status, are modeled as data in a relational database. Various network data, such as router states and link states are abstracted into tables in the relational database. Tables in the database can be constructed at various levels of abstraction, as required to satisfy network operational demands. Programmability may be provided by a declarative language composed of a series of database queries and insertions. (The term “insertions” includes insertions, updates and deletions.) Network management operations may then be represented as a series of transactional database queries and insertions. As a result, the database automatically propagates, to the appropriate network elements, state changes that are written to database tables, thereby implementing various network operations. (The term “network operations” as used herein includes activities that network operators perform to maintain operation of a network. Network operations may include, for example, network configuration management, network fault management, network performance management—including traffic, emergency and security management, network planned maintenance, or any other type of network management, and work flows associated with such operations. The term “network” refers to a system with a group of elements that communicate with each other. One embodiment of a network involves a group of electrical and/or optical elements that interact to form, for example, a computer network or a communications network.)

An aspect of the disclosed technology is rooted in the recognition that automation can only be achieved in a closed-loop fashion where the operational actions are informed by the state of the network, which reflects the result of previous operational actions as well as the dynamic behavior of the network. In one embodiment of the disclosed technology, an automated operations/management system may involve related database tables that are at various levels of abstraction. Abstractions may be used in complicated systems in order to hide unnecessary details; however, those exact same details that are best hidden for one task might be important to expose in another task. In large part, the dearth of automation in network management operations is due to a lack of programmability at various levels of abstraction, depending on need. In the disclosed technology, we use a database-oriented declarative language approach to facilitate both programmability as well as the ability to realize different abstractions over the same data and thus to serve as a unifying framework towards automated network operations. Different tables may represent the network at different levels of abstraction; for example, different tables may represent the network at service, network, or device levels of abstraction.

In the disclosed technology, network management operations can be represented as a series of transactional database queries and insertions, which provide the benefit of atomicity, consistency and isolation. The rule-based language that may be used provides the flexible programmability to specify and enforce network-wide management constraints, and achieve high-level task scheduling. In the disclosed technology: 1)network operators can write queries to audit and reason about the status of the current networks; 2) a network operation task may be expressed as a database transaction, which contains a series of updates and queries against the database and changes to the database may be automatically propagated to network elements; 3) network administrators can create declarative, high-level policies as global database constraints and those declarative policies may be translated into imperative enforcement mechanisms to prevent policy violations during executions of the transactions.

In the following, we present a short, high-level overview of the disclosed technology, then examine the fundamental components of management operations, and present a more detailed architectural overview of the disclosed database-oriented declarative approach to automated network management.

### Short High Level Overview

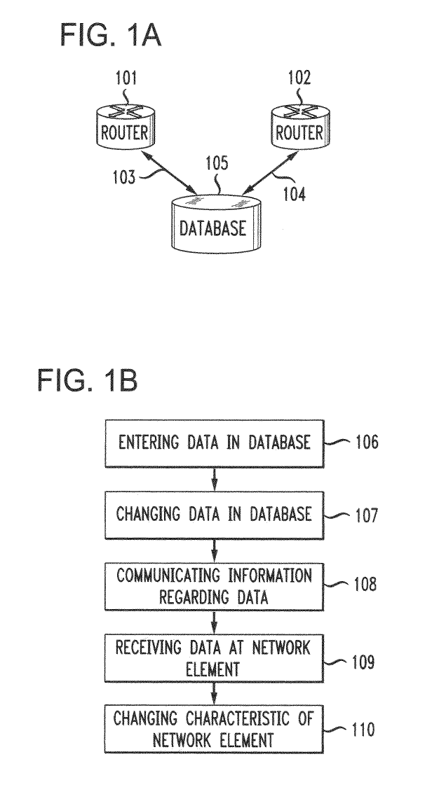

FIG. 1A is a high level view of an embodiment of an apparatus used in the methodology of the disclosed technology. In FIG. 1A, 105 is a relational database having related data tables whose generic characteristics are well known to those having ordinary skill in the art. The database, 105, is maintained in a memory device, such as a solid state, optical or magnetic memory, and various dynamic or static memory positions or addresses in the memory device may be associated with cells in the various tables of the database. In FIG. 1A, 101 and 102 are exemplary network elements, such as routers in a communications network. Information associated with routers, such as the router connections, router capability, router state, etc, may be stored in cells of the various tables of the database. In FIG. 1A, 103 and 104 are communication lines between the routers and the database. These lines enable the database to be updated, perhaps automatically, regarding the status of the routers, and enable the routers to be informed of the data in the database related to each router's characteristics. Network operational personnel may operate the network by making changes in the data associated with one or more network elements. Changes in the database may be made based on rules that are automatically implemented. Information associated with these changes are then communicated to the network elements through 103 and 104 and one or more characteristics of the network elements may be changed based on the changed data in the database. The relevant network elements will have associated well known elements that will permit the network element to receive the information and make a change or changes in the network element based on the information. For example, each network element may have associated general purpose computer functionality, for example, in a controller, that can communicate with other entities, including the database system. It receives the information and implements appropriate changes in the network element, based on the information. The changes may involve, for example, the router state or router link connections. In this way, the network may be operated. It will be understood by those having ordinary skill in this art that any network elements can be the subject of database entries, including for example, routers, switches, links and other network nodes. Data in the database may represent any characteristic of the network elements. The database may be centralized or may be distributed over various appropriate network elements, such as central processor units associated with routers.

FIG. 1B is an embodiment of the methodology of the disclosed technology. In FIG. 1B, at 106, data, representative of characteristics associated with at least two components of a network, are entered at addresses of a memory device associated with cells of at least two tables in a relational database. The data may be associated with the same characteristic in each of the two components or with different characteristics for each component. At 107, data representative of a characteristic of at least one component of the network is changed in at least one of the tables of the database. At 108, information, associated with the data change, is communicated to the one component. In additional steps, that may be practiced in alternative embodiments, at 109 the information associated with the data change is received at the one element, and at 110 a characteristic of the one element is changed based on receipt of the information.

### Fundamental Concepts of Network Operation

Network operations are fundamental to the well-being of today's networks. In operational networks, network operations are usually performed manually, or in a semi-automated fashion, via so called method of procedure (MOP) documents. MOPs describe the procedures to follow in order to realize specific operational tasks, often via manual command line interface (CLI) procedures. The procedures usually serve as a template that stitches the following four components together to achieve actual network management tasks:

Configuration management: The configuration of network elements collectively determines the very functionality provided by the network in terms of protocols and mechanisms involved in providing functionality, such as basic packet forwarding. Configuration management, or more generically all commands executed via the operational interface of network elements, are also the primary means through which most network operational tasks are performed.

Status checking: Obtaining network running status is an important part of network management. The result of status-checking activities largely determines the actual progress of network operational tasks. As a trivial example, a BGP (Border Gateway Protocol) session configuration would only be carried out on a router after IP level connectivity to the remote BGP peer has been verified.

External synchronization: Today's networks may be inherently managed by multiple parties. While devices can be logically accessed from a central location, field operators are essential in carrying out operations on the physical infrastructure of the networks. There are also external decision systems that can guide various types of management tasks, such as router or link maintenance. From a network management system point of view, it is important to have the capability of synchronizing with these external parties.

High-level constraints: While making changes to the networks, there are usually certain constraints that should never be violated. For a large ISP network with many routers and inter-links, link maintenance is performed all the time. A bottom-line constraint could be “never partition the network”.

### Aspects of the Disclosed Technology

The disclosed technology involves use of a database abstraction for network operations. We abstract router state and network state into tables in a conceptually centralized relational database that may, however, be distributed over network elements. Programmability may be provided by a declarative language composed of a series of database queries and insertions. As a result, the database automatically propagates state changes from database tables to network elements such as routers to carry out network operations. Various embodiments of the disclosed technology may include one or more of the following characteristics:

Flexible Levels of Abstractions: An automated network management system suitable for operational tasks requires programmability at an appropriate level of abstraction. A low-level abstraction may expose too much unnecessary details and have high complexity. On the other hand, a high-level abstraction may hide some important details that are required for certain operations. Managing network elements, such as routers, using databases, not only raises the abstraction to a higher level than the MOP/CLI approach, but also provides the ability to realize different abstractions over the same data by creating views on top of the base tables. For example, one could derive a path view that describes all paths established by a routing protocol based on a link table, which describes link relation between routers and is extracted from each router. As a result, operations and policies based on path properties can be directly specified against the derived view.

Configuration and Status Unification: In the disclosed technology, both router configurations and network status may be represented as relational tables. Queries and insertions can then be written that configure routers based on different network conditions.

Transactional Operation: Network operations are represented as a series of transactional database queries and insertions, which provide the benefit of atomicity, consistency and isolation. Should any failures or policy violations occur, the disclosed technology reverts the system to a previous consistent state.

Declarative Policy Enforcement: The disclosed technology enables network operators and administrators to specify high-level policies (i.e., constraints). Generally, such policies are implemented by specifying one or more constraints between the data associated with the network elements. For example, one may specify that each router must have a unique interface identifier, or at least one of two important links must be up. These policies are expressed independently from the authors of operation transactions, and are considered declarative in that they describe what should happen as opposed to how to enforce them during each network operation. Such enforcement mechanisms may be automatically generated from the policies using the disclosed technology.

### Architecture

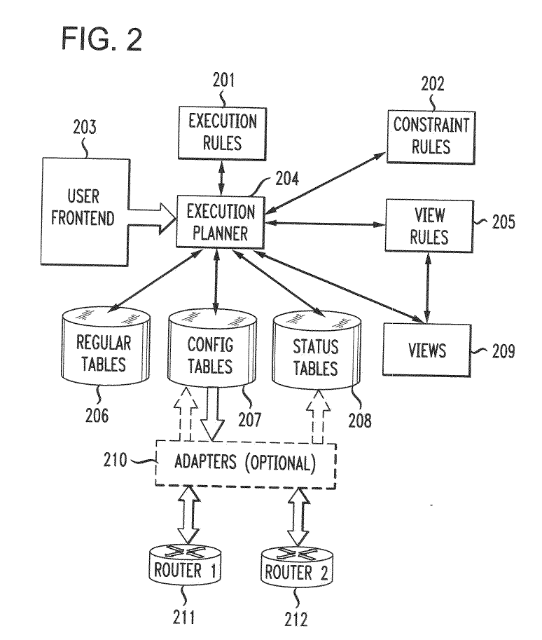

An embodiment of the architecture using the disclosed technology is depicted in FIG. 2. In this embodiment tables, 206, 207 and 208, and views, 209, reflect router configurations and network status. Network operations and constraints, 202, are expressed as rule-based database queries and insertions. They are fed into the execution planner, 204, where automated execution programs are generated to manipulate the tables and views. Relevant state changes in the tables are communicated to the corresponding routers, 211 and 212. For commodity routers that do not support the database abstraction, adapters, 210, may be used to bridge the gap. A user interface, 203, is provided for operators to examine data and execute operations. The user interface may be a standard data entry module, including for example and keyboard and a screen and perhaps computer resources.

All states involved in operation tasks are modeled as relational data, and stored in one of the following types of tables: i) regular tables, 206, that are similar to tables in a traditional database. Their state is not associated with any router. Such tables are typically used to store auxiliary execution states for an operation, such as the stage of a multi-stage operation; ii) config tables, 207, store router, or other network element, configuration information, such as IP addresses, protocol-specific parameters, interfaces, etc. One can read these tables to get current configuration, and also write to those tables to change the configuration. Consistency is maintained between config tables and the router states. For example, an update of the “interface” table entry “interface (if_id, “down”) effectively triggers CLI commands that shut down the relevant interface; iii) status tables, 208, represent the current network state. For example, a ping(Src,Dest,RTT) table represents the ping result between two routers Src and Dest. These tables may be read-only, and maintained in an on-demand fashion: status from the routers are only obtained when relevant status table entries are referenced in a query.

Language: The disclosed technology may adopt a rule-based query language such as Mosaic™ which is, a variant of Datalog, for operators and administrators to program automated network operations. Datalog is known to be more expressive in representing recursive queries than SQL, which is desirable to describe network properties. In the disclosed technology, three types of rules are utilized for different purposes: i) execution rules, 201, are used to define automated network operations. They are usually in the form of event-condition-actions (ECA rules). For example, a startOp(RouterlD) event triggers the execution of an ECA rule, and depending on current router configurations and network status (i.e., conditions), different actions are taken to carry out the operation. In a complicated operation, an action may trigger other events, which further lead to other actions that are dictated by other execution rules; ii) constraint rules, 202, specify the policies of a network as the consistency conditions of the database. Any actions in execution rules should not make the database inconsistent; iii) view rules, 205, are used to create views that are derived from existing tables or views. Views provide different levels of abstractions.

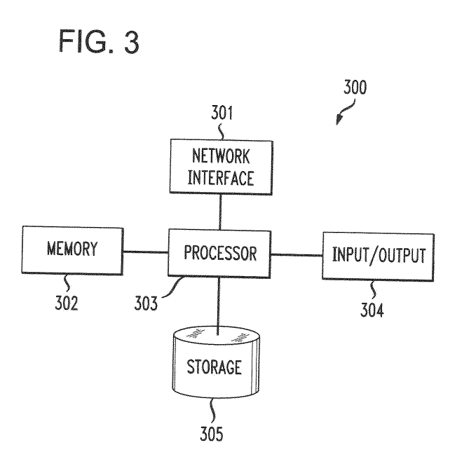

FIG. 3 shows a high-level block diagram of a computer that may be used to carry out the invention. Computer 300 contains a processor 303 that controls the overall operation of the computer by executing computer program instructions which define such operation. The computer program instructions may be stored in a storage device 305 (e.g., magnetic disk, database) and loaded into memory 302 when execution of the computer program instructions is desired. Thus, the computer operation will be defined by computer program instructions stored in memory 302 and/or storage 305, and the computer will be controlled by processor 303 executing the computer program instructions. Computer 300 also includes one or more network interfaces 301 for communicating with other devices. Computer 300 also includes input/output 304 representing devices which allow for user interaction with the computer 300 (e.g., display, keyboard, mouse, speakers, buttons, etc.). One skilled in the art will recognize that an implementation of an actual computer will contain other components as well, and that FIG. 3 is a high level representation of some of the components of such a computer for illustrative purposes. It should also be understood by one skilled in the art that the method of the current invention may be implemented on a device such as is shown in FIG. 3 by, for example, utilizing appropriate computer instructions as described herein.

### EXAMPLES

Basic link maintenance procedure: In what follows, we use the example of link maintenance with increasing sophistication to show how different aspects of network management can be expressed as declarative rules. We also indicate how the execution engine picks up and executes rules to automate management operations.

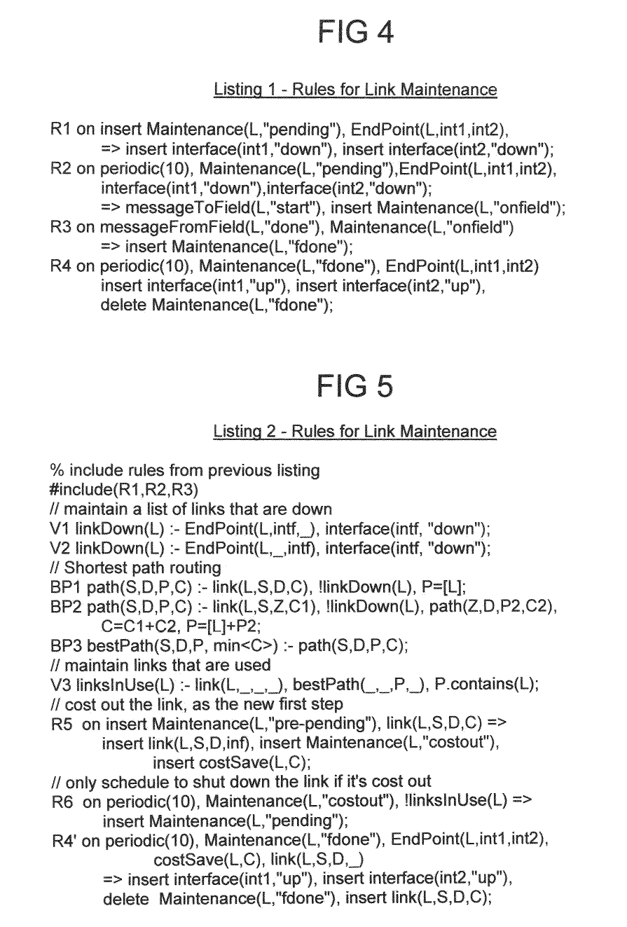

From a network operator's perspective, the basic operational procedure of link maintenance includes: 1) shut down the interfaces on both ends of the link; 2) coordinate with field team so that they work on the physical part of the link; 3) bring up the interfaces. Listing 1, detailed in FIG. 4, shows how to use four execution rules (R1-R4) to realize a simple maintenance procedure. Three tables are used in the example: the Maintenance table contains a list of links that are under-going maintenance procedures, associated with its up-to-date procedure status; the EndPoint table records each link and the interface IDs of its two ends; the interface table is a config table to bring up or down router interfaces. Modifying the state of an interface from “up” to “down” would result in configuration changes automatically populated to the actual devices. There are two events messageToField and messageFromField in this example. They are sent and received respectively via the user front-end to interact with operators.

R1-R4 are event-condition-action (ECA) rules. They are triggered by events, including user-defined events, system events, or database events. The actions of a rule are executed when all conditions hold. Specifically, R1 fires when a new link maintenance task on link L is scheduled, indicated by the insertion event of a tuple (L, “pending”) into the Maintenance table. Then the endpoint interfaces int1 and int2 of the link L are identified. Finally, both interfaces are shut down by changing the interface table. The details of how this change is done are will be obvious to the rule writer having ordinary skill is this art.

R2 and R3 are used to carry out external synchronization. periodic(10) represents a system event that is triggered every 10 seconds. So, R2 is periodically triggered to find a link L in “pending” state and both of its interface endpoints are already shut down, then performs the actions of notifying field team to start working and shortest path routing protocol declareRoute. Basically, BP1-2 computes the paths (P) with cost (C) between a source (S) and destination (D), in a recursive fashion. Note that we add additional dependency on linkDown to make sure a down link is not used. BP3 selects the best path between any pair of source and destination. We assume the routing table is set up according to the bestPath view. Rule V3 is used to derive a list of links that are currently used from the routing table. Next, in rule R5, we introduce a new state of “pre-pending” for a link in the Maintenance table. To maintain a link, (L,“pre-pending”) should be inserted to take advantage of the additional sophistication. R5 states that for each link in “pre-pending” state, we first change its link cost to infinity (inf). This would effectively remove the link from the current routing table. R6 states that only if the link L is confirmed not to be used in the routing table, can we transit it to the “pending” state, resulting a shut down by R1 (included from listing Ist.mt1). We use R4′ to replace the original R4, adding the action to restore the link cost of L. Note that this program is meant to exemplify how the network status observation can be integrated into the network operations. Our system does not require the routing protocols to be implemented declaratively. We can simply populate a status table with up-to-date network routing state and write queries and insertions based on that.

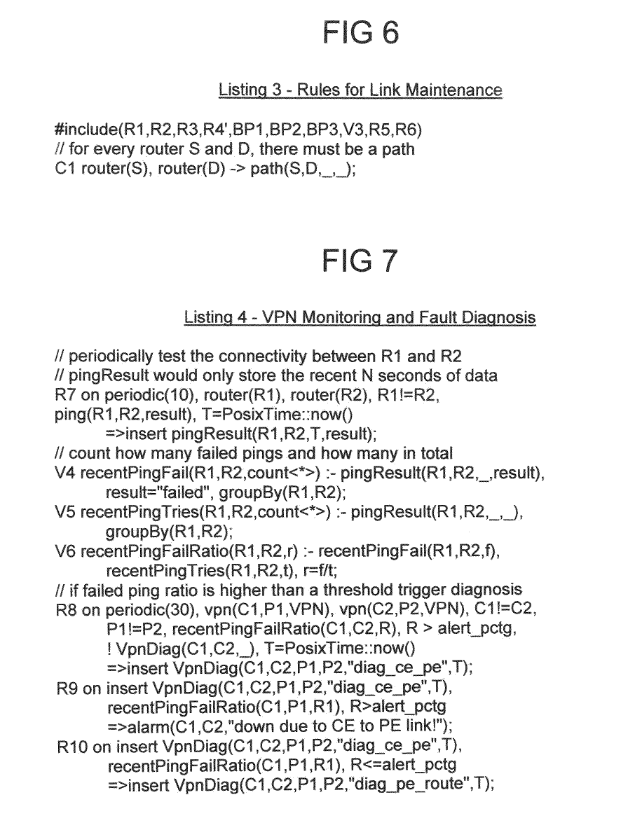

Constraint enforcement: While the rules in the above two programs can help the careful progression of a link maintenance task, some operators may include some other rules to manipulate interface table in other ways. The combination of these programs may introduce an undesirable state, such as network partition. In this example, we introduce the usage of constraint rules. C1 in Listing 3, detailed in FIG. 6, is a simple way to express, for any two routers C and D, that there is always a path between them. Note that constraint rules are assertions that do not change any state, unlike ECA rules where the actions do make state changes. Constraints can be used to expressed high-level policies over all the network operations. The constraints can be “do not partition the network”, “do not cause traffic oscillation more than X percent”, etc. When an execution rule firing has the potential of violating these constraints, that rule firing is canceled or delayed to retry at a later time.

Network Monitoring and Fault Diagnosis: Listing 4, detailed in FIG. 7, shows how to build a simple network connectivity monitor and further automates VPN connectivity problem diagnosis.

R7 is a very straightforward rule used to get raw connectivity data: it is triggered every 10 seconds for every pair of routers, a ping table query is issued and the ping result stored in pingResult table. As a status table, any query to the ping table is translated to a ping command on the corresponding router. V4 and V5 are views that count the number of failed and total ping trials between any pair of routers based on the pingResult table. V6 calculates the failure ratio between all pairs of routers within the recent N seconds. This exemplified capability of building high-level abstraction over relatively low-level data elements.

R8 monitors VPN connectivity by firing every 30 seconds and finding two CE routers C1 and C2, that are within the same VPN but connecting to different PEs (P1 and P2): if the ping failure ratio is between the two CEs is higher than a pre-defined threshold, an automatic diagnosis procedure on this pair of CEs is started. Note that, !VpnDiag(C1,C2,) is used as a condition to prevent launching a diagnosis procedure for the same pair of CEs twice.

VPN diagnosis is very complicated and may advantageously use multiple steps to narrow down the problem. For brevity, we only show one step in the example. In this step, we need to verify if the CE C1 can reach the PE P1 correctly. R9 and R10 check the failure ratio between C1 and P1: 1) if the ratio is higher than a threshold, R9 is fired, meaning that the problem is confirmed to the connectivity loss between CE and PE and thus an alarm is generated; 2) otherwise, R10 is fired, moving on to next stage diagnosis “diagperoute”, which tries to determine if the CE router's loopback IP exists in the PE router's VRF table.

A wide range of network monitoring and follow-up automated responses can be expressed similarly. For example, the following rule can be used to monitor link usage and perform rate-limiting automatically: on periodic(10), LinkUsage(L,R), R>0.8=>RateLimit(L).

### Some Further Database Details:

Following are database details that may be used in embodiments of the invention. A table in the database may be defined with a list of column names and types, together with primary keys for indexing. Entries of a table may be inserted when the program starts as facts or dynamically inserted, and may be updated or deleted during program execution, as we show in the examples. Most of dynamics within the disclosed technology may be expressed in ECA rules (event, condition, action), using the operator “=>”. Each ECA rule indicates that when an event occurs and all specified conditions are satisfied, the listed actions should take place. On the left side of “=>”, first comes the event that would trigger this rule, followed by zero, one or more conditions that must be satisfied for the rule to actually fire. On the right side, a list of actions are given. The view update event would only occur when the view table is changed. The conditions are generic C-style expressions, C>10, X!=Y. From a higher-level, the conditions express the desired network state for the rule to fire. Actions of an ECA rule can be: 1) database actions, insert link(X,Y,C); 2) system actions, like print messages, dump table entries, exit the program; 3) injection of defined events.

### Some Further Elements of Alternative Embodiments

Alternative embodiments of the disclosed technology include: 1) programming network elements to transmit notification when relevant events occur on the elements, e.g., router table update, router interface status change, etc; 2) preventing transient bad network states by undoing rules fired, one by one in reverse order, if failure occurs; 3) using a sequence of rules to handle a failure analogous to any other network operation; 4) Canceling or delaying a rule if one of the constraints may no longer hold if the rule fires at the current network state; 5) prioritizing rule execution; and 6) off loading portions of the database tables and rule processing to the distributed devices in the network.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiment of the disclosed technology shown and described herein are only illustrative of the principles of the claimed invention and that various modifications may be implemented by those skilled in the art without departing from the scope and spirit of the invention. Those skilled in the art could implement various other feature combinations without departing from the scope and spirit of the invention. Accordingly, it should be understood that the claimed invention may be broader than any given embodiment described in this specification, or than all of the embodiments when viewed together. Rather these embodiments are meant to describe aspects of the disclosed technology, not necessarily the specific scope of any given claim.

1. A method comprising:
a. changing, at an address of a memory device, the address associated with a cell of a table in a relational database, data representative of a characteristic associated with a component of a network; and
b. communicating, to a component of the network, information associated with the data change.

2. The method of claim 1 further comprising changing the characteristic based on the communicated information.

3. The method of claim 1 wherein the component of the network to which the information is communicated is the same component that has a characteristic represented by the data, and further comprising changing the characteristic of the component to which the information is communicated, based on the communicated information.

4. The method of claim 2 wherein the database is a centralized database.

5. The method of claim 2 wherein the database is distributed over a plurality of network components.

6. The method of claim 2 wherein the one component is selected from the group consisting of a switch, a router and a communications link.

7. The method of claim 2 wherein a declarative, rule-based language is used to interact with the database.

8. The method of claim 2 wherein each of at least two tables in the database represent the network at a different level of abstraction.

9. The method of claim 8 wherein the levels of abstraction are selected from the group consisting of service, network and device levels of abstraction

10. The method of claim 2 wherein changing the characteristic of the at least one component is associated with a network operation selected from the group consisting of planned maintenance, emergency repair, fault management, configuration management, traffic management, performance management, and security management.

11. The method of claim 2 further comprising specifying a constraint in the relationship between the data associated with at least two network elements.

12. A method of operating a network comprising:
a. receiving information associated with a change in data entered in a memory device, the data entered at a memory position of the memory device associated with a cell of a relational database, the data being associated with a characteristic of a component of a network; and
b. changing the characteristic of the component based on the received information.

13. A network comprising:
a. at least two network devices
b. a memory device with memory positions associated with cells of at least one table of a relational database, the cells associated with at least one characteristic of at least one network device;
c. a data entry device for entering data into the memory positions;
d. a communication device for communicating information associated with a change in the data in a memory position associated with the at least one characteristic of the at least one network device, and
e. the at least one network device adapted to change a characteristic of the at least one network device based on the communicated information.

14. The network of claim 13 wherein the database is centralized.

15. The network of claim 13 wherein the database is distributed over a plurality of network devices.

16. The network of claim 13 wherein the network device is selected from the group consisting of a switch, a router, and a communications link.

17. The network of claim 13 wherein the database is adapted for use with a declarative, rule-based language.

18. The network of claim 13 wherein each of at least two tables in the database represent the network at a different level of abstraction.

19. The network of claim 13 wherein the levels of abstraction are selected from the group consisting of service, network and device levels of abstraction

20. The method of claim 2 wherein the database is adapted to constraint the relationship between the data associated with the two network elements
